(19) United States
(12) Patent Application Publication
(10) Pub. No.: US 2009/0327453 A1
(43) Pub. Date: Dec. 31, 2009

(54) METHOD FOR IMPROVING DATA READING SPEED OF A DISKLESS COMPUTER

(76) Inventor: Neng-Chien YU, Pingjhen City (TW)

Correspondence Address: Hershkovitz & Associates, LLC, 2845 Duke Street, Alexandria, VA, 22314, US

(21) Appl. No.: 12/165,402

(22) Filed: Jun. 30, 2008

(51) Int. Cl. G06F 15/16

(52) U.S. Cl. 709/219

(57) ABSTRACT

A method for improving data reading speed of a diskless computer is applied to at least one diskless computer and a remote server having at least one disk drive and a cache unit. The method comprises acts of retrieving a data reading request from the diskless computer, determining if the requested data is in the cache unit, transferring the requested data from the cache unit to the diskless computer when the requested data is in the cache unit and transferring the requested data from the at least one disk drive to the diskless computer and the cache unit when the requested data is not in the cache unit. Therefore, speed of the diskless computer reading data from the remote server increases because access speed of the cache unit is faster than a conventional disk drive.

### BACKGROUND OF THE INVENTION

1. Field of the Invention

The present invention relates to a method, and more particularly to a method for improving data reading speed of a diskless computer.

2. Description of Related Art

Many enterprises require multiple computers for staff to work and may use multiple individual personal computers (PCs) or a WAN boot personal computer (WBPC) service to build their computer systems. As described below, individual PCs suffer from data security and management problems and have a high per unit cost, so WBPC systems may be preferred. The WBPC service comprises a WAN boot server (WB server) and at least one WBPC. The at least one WBPC is a personal computer without any disk drives, and the operating system, application programs and user data of the WBPC are stored in disk drives in the WB server. The WBPC must have a host bus adapter (HBA) installed to connect to the WB server and access the disk drives in the WB server over the Internet with the Internet small computer system interface (iSCSI) protocol. The iSCSI protocol is a data transmission technique that transfers blocked data rather than conventional filed data. Data transferred by using the iSCSI protocol has higher data transmission efficiency. Furthermore, all data of the WBPC are centrally managed and stored so safety and security of the data of the WBPC are higher for the enterprise than multiple singular PCs.

Though the WBPC service has such advantages, it still has some shortcomings. When an operating system kernel of the WBPC executes an application program to access data, the WBPC has to connect to the WB server to access the disk drives in the WB server. However, each disk drive in the WB server comprises mechanical structure. When many WBPCs try to access data in one disk drive in the WB server at the same time, a read-and-write head of the disk drive will be working almost continuously. The more WBPCs try to access data in one disk drive in the WB server, the higher loading of the disk drive results in lower data access efficiency and longer time for accessing data. Furthermore, the disk drive may be damaged because of the high loading of the disk drive. In addition, because the operating system kernel of the WBPC that accesses data from the busy disk drive waits for the response from the busy disk drive, the executing application program will become idle until the operating system kernel receives the response from the busy disk drive. Therefore, some resources of the WBPC will be consumed waiting for the response from the busy disk drive so the data access efficiency of the WBPC is reduced. The described shortcomings are the main reasons why the WBPC service cannot replace the individual PCs in enterprises.

To overcome the shortcomings, the present invention provides a method for improving data reading speed of a diskless computer to mitigate or obviate the aforementioned problems.

### SUMMARY OF THE INVENTION

The main objective of the invention is to provide a method for improving data reading speed of a diskless computer.

The method in accordance with the present invention is applied to at least one diskless computer and a remote server having at least one disk drive and a cache unit. The method comprises acts of retrieving a data reading request from the diskless computer, determining if the requested data is in the cache unit, transferring the requested data from the cache unit to the diskless computer when the requested data is in the cache unit and transferring the requested data from the at least one disk drive to the diskless computer and the cache unit when the requested data is not in the cache unit. Therefore, speed of the diskless computer reading data from the remote server increases because access speed of the cache unit is faster than a conventional disk drive. Furthermore, lifespan of the at least one disk drive in the remote server will be extended because the at least one disk drive in the remote server is not required to be accessed frequently.

Other objectives, advantages and novel features of the invention will become more apparent from the following detailed description when taken in conjunction with the accompanying drawings.

### BRIEF DESCRIPTION OF THE DRAWINGS

FIG. 1 is a functional block diagram of a diskless computer and a remote server for a method in accordance with the present invention; and

FIG. 2 is a flow chart of the method in accordance with the present invention.

### DETAILED DESCRIPTION OF PREFERRED EMBODIMENT

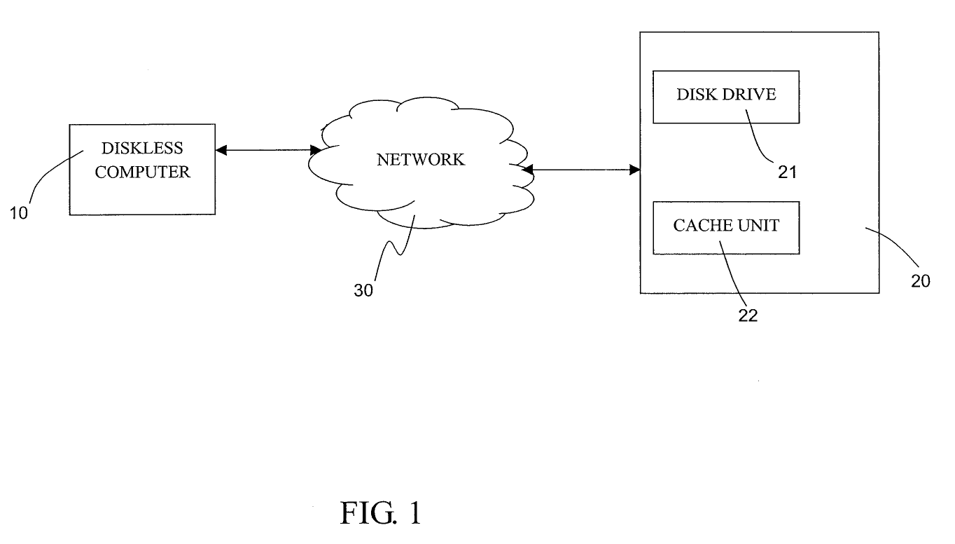

With reference to FIG. 1, a method for improving data reading speed of a diskless computer in accordance with the present invention is applied to at least one diskless computer (10) and a remote server (20).

The remote server (20) is connected to the at least one diskless computer (10) over a network, such as the Internet, and comprises at least one disk drive (21) and a cache unit (22).

The at least one disk drive (21) is for storing data, such as operating system data, application program data, user data and the like. Each disk drive (21) may be an integrated device electronics (IDE) disk drive, a small computer system interface (SCSI) disk drive, a serial advanced technology attachment (SATA) disk drive, a storage area network (SAN) storage device or the like.

The cache unit (22) may be a main memory of the remote server (20), such as synchronous dynamic random access memory, double data rate random access memory or the like, or a flash memory additionally installed on the remote server (20).

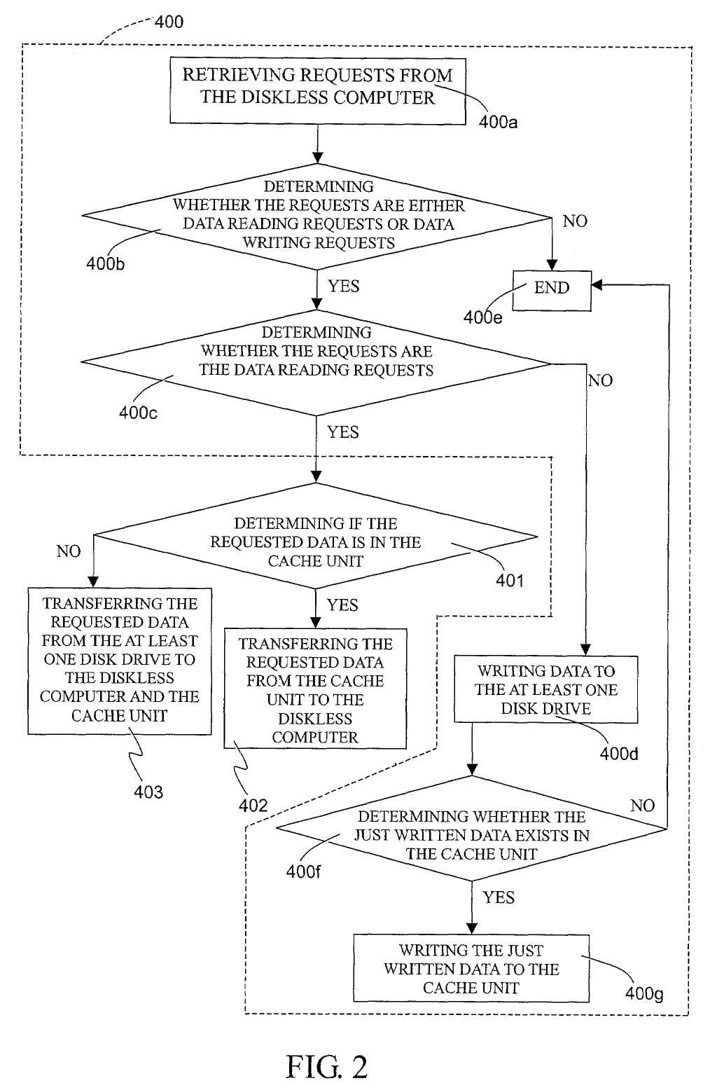

With reference to FIG. 2, the method of the present invention comprises acts of retrieving a data reading request from the diskless computer (400), determining if the requested data is in the cache unit (401), transferring the requested data from the cache unit to the diskless computer (402) when the requested data is in the cache unit and transferring the requested data from the at least one disk drive to the diskless computer and the cache unit (403) when the requested data is not in the cache unit.

The act of retrieving a data reading request from the diskless computer (400) comprises the remote server (20) retrieving a data reading request from the diskless computer (10) and may further comprise sub-acts of retrieving requests from the diskless computer (400a), determining whether the requests are either data reading requests or data writing requests (400b), determining whether the requests are the data reading requests (400c) when the requests are either data reading requests or data writing requests, writing data to the at least one disk drive (400d), optionally determining whether the just written data exist in the cache unit (400f) and optionally writing the just written data to the cache unit (400g) when the just written data exist in the cache unit.

The sub-act of retrieving requests from the diskless computer (400a) comprises the remote server (20) retrieving requests from the diskless computer (10).

The sub-act of determining whether the requests are either data reading requests or data writing requests (400b) comprises the remote server (20) determining whether the requests are either data reading requests or data writing requests. If the requests are neither data reading requests nor data writing requests, the flow is ended (400e).

The sub-act of determining whether the requests are the data reading requests (400c) comprises the remote server (20) determining whether the requests are the data reading requests when the requests are either data reading requests or data writing requests.

The sub-act of writing data to the at least one disk drive (400d) comprises the remote server (20) writing data from the diskless computer (10) to the at least one disk drive (21).

The sub-act of determining whether the just written data exist in the cache unit (400f) comprises the remote server (20) determining whether the just written data exist in the cache unit (22). If the just written data do not exist in the cache unit (22), this means that the just written data have never been read before or may be not frequently accessed by the diskless computer (10) so the flow is ended (400e).

The sub-act of writing the just written data to the cache unit (400g) comprises the remote server (20) writing the just written data to the cache unit (22) when the just written data exist in the cache unit (22). When the diskless computer (10) tries to read the just written data later, the remote server (20) can transfer the just written data from the cache unit (22) to the diskless computer (10).

The act of determining if the requested data is in the cache unit (401) comprises the remote server (20) determining whether the requested data is in the cache unit (22) when the remote server (20) determines the requests are the data reading requests.

The act of transferring the requested data from the cache unit to the diskless computer (402) comprises the remote server (20) transferring the requested data from the cache unit (22) to the diskless computer (10) when the requested data is in the cache unit (22).

The act of transferring the requested data from the at least one disk drive to the diskless computer and the cache unit (403) comprises the remote server (20) transferring the requested data from the at least one disk drive (21) to the diskless computer (10) and the cache unit (22) when the requested data is not in the cache unit (22).

Therefore, the at least one disk drive (21) in the remote server (20) is not required to be accessed frequently, and for this reason the lifespan of the at least one disk drive (21) in the remote server (20) will be extended. Furthermore, the speed of the diskless computer (10) reading and writing data in and to the remote server (20) will increase because the access speed of the cache unit (22) is faster than a conventional disk drive in general. A user of the diskless computer (10) will feel that the access efficiency of the diskless computer (10) is enhanced.

Even though numerous characteristics and advantages of the present invention have been set forth in the foregoing description, together with details of the structure and function of the invention, the disclosure is illustrative only. Changes may be made in detail, especially in matters of arrangement of parts within the principles of the invention to the full extent indicated by the broad general meaning of the terms in which the appended claims are expressed.

What is claimed is:

1. A method for improving data reading speed of a diskless computer comprising acts of:
retrieving a data reading request from a diskless computer by a remote server;
determining if the requested data is in a cache unit of the remote server;
transferring the requested data from the cache unit to the diskless computer by the remote server when the requested data is in the cache unit; and
transferring the requested data from the at least one disk drive to the diskless computer and the cache unit by the remote server when the requested data is not in the cache unit.

2. The method as claimed in claim 1, wherein the act of retrieving a data reading request from a diskless computer by a remote server further comprises sub-acts of:
retrieving requests from the diskless computer by the remote server;
determining whether the requests are either data reading requests or data writing requests by the remote server;
determining whether the requests are the data reading requests by the remote server when the requests are either data reading requests or data writing requests; and
writing data from the diskless computer to the at least one disk drive by the remote server.

3. The method as claimed in claim 2, wherein the act of retrieving a data reading request from a diskless computer by a remote server further comprises sub-acts of:
determining whether the just written data exist in the cache unit by the remote server after the act of writing data from the diskless computer to the at least one disk drive by the remote server; and
writing the just written data to the cache unit by the remote server when the just written data exist in the cache unit.
